(19) United States
(12) Patent Application Publication
(10) Pub. No.: US 2022/0357712 A1
(43) Pub. Date: Nov. 10, 2022

(54) SYSTEM AND METHOD FOR LEGALLY COMPLIANT, INTELLIGENT PROCESS CONTROL

(71) Applicant: Francotyp-Postalia GmbH, Berlin (DE)

(72) Inventors: Uwe Hübler, Neuenhagen (DE); Clemens Heinrich, Oranienburg (DE); Stephan Günther, Glienicke (DE)

(73) Assignee: Francotyp-Postalia GmbH, Berlin (DE)

(21) Appl. No.: 17/738,112

(22) Filed: May 6, 2022

(30) Foreign Application Priority Data
May 7, 2021 (DE) 102021111936.7

(51) Int. Cl. G05B 19/042

(52) U.S. Cl. CPC G05B 19/042; G05B 2219/2639

(57) ABSTRACT

A system and a method for the legally compliant, intelligent control of processes in a plant for the generation and/or provision of energy is provided. The system includes at least an acquisition device, an auditor device, an action device and a signing device. The system or the method enables the deduction of error sources. In addition to normal status reports, particularly advantageously relevant process occurrences, i.e., for example, deviations from defined specifications, options for action can be created automatically by an expert system and their selection can be reported to defined persons/bodies and/or initiated via a digital signature method and system with a tamper-proof time stamp. In addition, a confirmation is provided with a legally compliant digital signature, which enables retroactive control of the process plant or plant components, in particular via the action device.

The invention relates to a system and a method for the legally compliant, intelligent control of processes in a plant for the generation and/or provision of energy. The system comprises at least one acquisition device, an auditor device, an action device and a signing device. The acquisition device is configured to automatically acquire plant-related process variables. The auditor device, on the other hand, is configured to analyze the acquired process variables and to identify a trigger event. Furthermore, the auditor device is able to generate a first data set comprising the acquired process variables and/or an information value about the trigger event. The auditor device is able to transmit this data set as a data object to the action device. In turn, the action device is configured to determine a signing device responsible for the data object. Further, the action device may create a requirement data set comprising a signature requirement and at least part of the data object. This requirement data set may be transmitted to the responsible signing device. Further, an action data set may be generated by the action device and provided to the auditor device. The signing device is adapted to generate a response data set comprising an electronic signature for at least part of the requirement data set. Furthermore, the response data set may be transmitted to the action device and/or to another signing device.

### BACKGROUND AND PRIOR ART

Process and plant control via the Internet is well known in the prior art. So-called IoT systems (Internet of Things) make it possible for a user to monitor and control processes and plants remotely on the basis of their operating and status parameters.

However, it is currently very time-consuming and cost-intensive to generate an automated response for troubleshooting that is optimally adapted to the respective situation as well as its legally compliant documentation in the event of malfunctions or exceptional states occurring as well as unexpected events that may affect an IoT system. There is therefore a great need for a solution to remedy this shortcoming.

Especially in plants for the generation and/or supply of energy, there are a large number of different safety-relevant processes that have to be monitored, controlled and documented. For example, all processes involving the connection and disconnection of sensors and actuators (such as electricity, water and energy meters, temperature and pressure transmitters as well as valves, pumps and electrical switchgear) of decentralized supply stations are affected.

The automated acquisition of process variables such as electricity, water or heat consumption via corresponding sensors, but also monitoring access to safety-relevant plant components/switching stations with the aid of chip card reading are known in the prior art.

However, there is no system and/or method that centrally processes the acquired parameters in a plant for the generation and/or provision of energy, analyzes them automatically and, in particular, ensures legally compliant forwarding of information to responsible persons/bodies in the event of critical process parameters being exceeded or not being met, so that a corresponding automated reaction by these bodies/persons is made possible and it is clearly documented afterwards how the flow of information has proceeded in terms of time and content.

### Objective of the Invention

The objective of the invention was therefore to eliminate the disadvantages of the prior art and to provide a cost-effective and automated system and method for legally compliant, intelligent control and documentation of processes in a plant for the generation and/or supply of energy.

### SUMMARY OF THE INVENTION

The objective according to the invention is solved by the features of the independent claims. Advantageous embodiments of the invention are described in the dependent claims.

In a preferred embodiment, the invention relates to a system for legally compliant, intelligent control of processes in a plant for the generation and/or provision of energy, the system comprising at least one acquisition device, one auditor device, one action device and one signing device, characterized in that
a) the acquisition device is adapted to automatically acquire plant-related process variables;
b) the auditor device is adapted to
   (i) analyze the acquired process variables and identify a trigger event;
   (ii) generate a first data set, the first data set comprising at least one of the acquired process variables and/or an information value about the triggering event;
   (iii) transmit the first data set as a data object to the action device;
c) the action device is adapted to
   (i) determine a signing device responsible for the data object;
   (ii) transmit a requirement data set to the signing device assigned to the data object, the requirement data set comprising a signature requirement and at least part of the data object;
   (iii) generate an action data set and provide the action data set to the auditor device;
d) the signing device is adapted to
   (i) generate a response data set comprising an electronic signature for at least part of the requirement data set;
   (ii) transmit the response data set to the action device and/or to a further signing device.

Such a system for solving the objective specified above is neither known from the prior art nor rendered obvious to an average person skilled in the art. Rather, the system according to the invention is to be regarded as a departure from the prior art, in which, in particular, acquired process variables and a control of processes are subjected exclusively to individual consideration and manual monitoring, analysis, transmission and/or processing steps must frequently be included. Whereas the system according to the invention offers the possibility to provide a fully automatically implemented system for legally compliant, intelligent control of processes—starting from the acquisition of process variables up to the configuration of plant-related parameters. Above all, the system also enables automated legally compliant documentation.

Advantageously, the system according to the invention enables the deduction of error sources on the basis of existing process information and thus the creation of possibilities for their automated elimination. In addition to normal status reports, it is particularly advantageous that relevant process events, i.e. e.g. deviations from defined specifications such as maximum consumption values in defined time intervals or also falling short of specified temperature and pressure values, can be evaluated automatically, options for action can be created automatically by an expert system and their selection can be reported to defined persons/bodies and/or initiated via a digital signature method and system according to the invention with a tamper-proof time stamp. In addition, an confirmation is given with a legally compliant digital signature, which enables retroactive control of the processing system or plant components, in particular via the action device. In this way, it is still possible to trace at any time which type of deviations or failures occurred at which time and which persons were informed about them and, moreover, which of the automatically suggested troubleshooting measures were selected. In this way, both root cause analysis and troubleshooting are significantly simplified and any existing process defects or even acute failures can be remedied. The signature requirements can be linked to process contents or to the type of process deviations, so that, for example, in the case of failures of several plant components simultaneously, the responsible plant managers as well as the superior management are informed and must confirm this via digital signature.

It has been shown that especially the feedback effects (control and regulation) on the plant for the generation and/or provision of energy allow extremely precise and efficient interventions in running processes, in process preparation and/or process follow-up in the plant from a remote location. However, the system does not exclude manual on-site control and regulation of processes in the plant for the generation and/or provision of energy (or components of the plant). On the contrary, one of the particular advantages is that the system enables a symbiosis or combination of manual and automated feedback effects on the plant, whereby these can be coordinated with each other.

The controls or regulations can be generated automatically, in particular by an action device, or by a manual input of a person/body by means of a signing device assigned to it. Especially the combination of manual interventions and automated interventions leads to a high degree of flexibility and security of the system. For this reason, the system can be adapted for many applications, so that automated control or regulation or manual control (or combinations thereof) is possible, depending on the requirements. It can also be provided that a manual input in a signing device is also verified by a subsequent analysis in the action device. A high degree of relevance is to be attributed to the action device, because this advantageously enables by its design a fast and comprehensive analysis of the acquired process variables and/or the information value about a triggering event, based on which control or regulation commands can already be generated in a direct way as a reaction and transmitted as an action data set to the auditor device. Depending on the application, the action device generates an action data set only after it has received control and/or regulation commands in a response data set by the signing device. In both cases, the action data set can be provided directly to the auditor device, which implements the commands included in the action data set. In this way, the system according to the invention meets particularly high reaction speed, safety and quality standards (where “quality” preferably means the type of reaction commands selected).

Within the meaning of the invention, a plant for the generation and/or supply of energy is preferably understood to mean a plant for the generation and supply of district heating. District heating is preferably referred to as a heat supply for supplying buildings with space heating and hot water. The thermal energy is preferably transported in a heat-insulated pipe system, which is predominantly buried in the ground, but overhead lines can also be used in some cases. District heating supplies residential buildings in particular not only with space heating but also with hot water by transporting the heat from a producer or a collection point to the consumers. The preferred heat suppliers in district heating networks are combined heat and power plants fired with fossil fuels, biomass or waste. These are preferably operated in a combined heat and power system and can thus achieve fuel savings compared with separate power and heat generation. In addition, waste heat from industrial processes, geothermal energy, solar thermal energy (solar district heating) and environmental heat harnessed by means of large heat pumps can also preferably be fed into district heating systems.

A plant for the generation and supply of district heating (also referred to as a district heating system) preferably comprises various main components. These include, in particular, the heat generation plants (often combined heat and power plants), the district heating network, which is usually operated with hot water, including pumping stations and building connections, and the transfer stations that deliver the heat to the building heating system.

District heating networks have the advantageous property of being able to use a large number of different heat sources very flexibly, which can be both centralized and decentralized. Preferably, district heating is generated in large combined heat and power (CHP) plants, smaller cogeneration plants, in waste incineration plants or district heating plants. Preferred fuels include various forms of coal, natural gas, biogas, oil, wood and wood products, solar thermal energy, and waste in various compositions and processing forms.

A plant for the generation and/or supply of energy can also preferably be understood as an energy power plant as such (preferably for the generation of electricity). In a power plant, mechanical energy is preferably converted into electrical energy by means of generators, which is fed into the power grid. The mechanical energy for driving the generators in turn preferably comes from kinetic energy (hydroelectric and wind power plants) or thermal energy (via, for example, steam turbines, gas turbines or ORC turbines). The thermal energy preferably comes from solar radiation energy (solar thermal power plant), geothermal energy (geothermal power plant), chemical energy (combustion of coal (coal power plant), petroleum (oil power plant), natural gas (gas power plant), biomass (biomass power plant), waste or nuclear energy (nuclear power plant), possibly nuclear fusion in the future. In another preferred embodiment, the energy power plant is designed from many similar small units, e.g. photovoltaic systems. They can also preferably be called power plants, although they do not contain any moving parts and therefore kinetic energy does not occur as a form of energy in the conversion chain.

It is preferred within the meaning of the invention that the acquisition device comprises at least one sensor or sensor system. A sensor can determine physical (e.g., amount of heat, temperature, humidity, pressure, sound field quantities, brightness, acceleration) or chemical (e.g., pH, ionic strength, electrochemical potential, analytical methods such as spectral or microbiological) properties and/or the material composition of its environment qualitatively or quantitatively as a measured variable. These quantities are acquired by means of physical or chemical effects and converted into an electrical signal that can be further processed. In a preferred embodiment, the acquisition device comprises a sensor selected from the group comprising: temperature sensor, displacement sensor, pressure sensor (force sensor), acceleration sensor, image sensor, touch sensor, humidity sensor, GPS sensor, NFC sensor, RFID sensor, analysis sensor, air quality sensor, current sensor, inclination sensor, strain sensor, flow sensor, level sensor, gas sensor, light sensor, radiation detector, sound sensor.

The sensors of the acquisition device are configured to automatically acquire plant-related process variables, which preferably comprise status information and/or operating information of individual plant components and/or plant processes. The combination of all information preferably results in comprehensive overall information, from which in particular very detailed knowledge about the plant for the generation and/or provision of energy as such as well as its included components and the generated energy is obtained.

In accordance with the invention, the acquisition device may also be divided into a plurality of acquisition devices, wherein the respective acquisition devices comprise different sensors. In a preferred embodiment, the acquisition device comprises a memory and a processor. This allows the acquisition device to subject the acquired information to pre-processing. This may, for example, comprise an initial analysis or filtering of the captured data, as a result of which the auditor device advantageously requires less power for data processing as well as memory.

The auditor device according to the invention is preferably to be seen as a data processing unit. It preferably comprises means for generating, processing, storing, transmitting and receiving data. The auditor device is preferably in data communication with the acquisition device, the action device and a report generator, whereby data can be transmitted bidirectionally between these system components. In a preferred embodiment, the auditor device executes algorithms and calculations by receiving input data from the acquisition devices and, after executing the algorithms, generates output data that is preferably transmitted to the action device and/or the report generator. The advantage of such an arrangement is that the acquisition device does not need to be equipped with components for data processing (processor) and data storage. Another advantage is that the auditor device can include a variety of acquired data from different acquisition devices for its analysis or execution of the algorithms, so that a wide-ranging analysis is possible.

Based on the acquired process variables, the auditor device can identify a trigger event. Within the meaning of the invention, a trigger event is preferably to be understood as an event that represents a discrepancy between an actual event and an event that is actually expected and/or planned, such that a notification to responsible entities (persons or bodies) and/or an action (as a reaction) is required. Preferably, a trigger event is also to be understood as a so-called “trigger”. A trigger event may also preferably be time-dependent, so that, for example, certain acquired process parameters may reach responsible entities (bodies/persons) as “milestones” at different time intervals. For example, a triggering event may be an exceedance of or failure to reach a temperature threshold, an overload of a generator, a valve damage, a leakage in a piping system, a lack of fuel, or a wrong orientation of photovoltaic modules (in relation to a solar irradiation). The analysis for identifying a trigger event can be based, for example, on artificial intelligence algorithms, or on a simple comparison between acquired values with reference values or other algorithms.

Further, the auditor device is preferably configured to generate a first data set. A data set is preferably stored as summarized data in databases or in files. Preferably, the data set is stored in a file format selected from the group comprising PDF, JSON, XML, CSV. PDF files are characterized by very high degree of universal usability on different data processing systems, while one of the great advantages of JSON files is the simplicity of implementation and use. Due to their simple structure, JSON files do not require a lot of resources during their use. Thus, large data can be evaluated in an acceptable time. The XML format can be advantageously linked to other systems without a high degree of complexity, so there is particularly good compatibility. XML is also advantageous for long-term file storage and XML can also be easily converted into other file formats. The CSV file format is advantageously versatile. The big advantage of the CSV format is furthermore the ease of transferability, such as for example importing into different databases or programs. In already existing databases, contents from CSV files can be input many times. It is particularly advantageous when different data sources (for example, data from different acquisition devices) are to be combined into a single data set.

In a preferred embodiment, sensor-specific raw data and/or prepared or processed raw data is transmitted by the acquisition device to the auditor device, which analyzes this data and stores an information value about plant-related process variables and/or a trigger event in the above-mentioned file formats. Accordingly, it is possible that the auditor device receives an image file and converts it into abstracted information, an XML or CSV file. The advantage of this procedure is that the raw data and/or prepared or processed raw data of the acquisition devices are converted into a form which requires a much smaller storage capacity and in addition makes use of all the other advantages of the file formats mentioned above. The loss of information due to the abstraction does not lead to any disadvantages in the further process sequences of the proposed invention.

A data object can preferably be understood as an umbrella term for data sets, formulae, analysis objects and data link objects, i.e. for all objects that contain data or provide a calculation result. Within the meaning of the invention, a data object preferably comprises one or more data sets.

The file formats to be used are not insignificant for the proposed system, because they have an influence on the calculation speed, the memory as well as the transmission speed. The interaction of the file formats with the auditor device, the action device, the report generator, the acquisition device and/or the signing device, among others, contribute to the technical character of the invention. It has further been shown that in particular the plant-related process variables as well as an information value about a trigger event can be stored particularly well in aforementioned file formats without having to accept relevant information losses.

The action device can preferably assign a signing device to the received data object or determine a responsible signing device. Accordingly, the action device preferably comprises means for generating, processing, storing, sending and receiving data. The assignment is made in particular on the basis of the information value about the trigger event included in the data object and/or on the basis of a process variable included in the data object and/or on the basis of an evaluation of the information values and/or process variables received. Here, the action device preferably has access to a database comprising all signing devices with their addressing information. This database can either be arranged on an external server or be arranged in the structure of the action device—i.e. in a memory—itself. Preferably, a responsible signing device for the information value of the data object is determined from the database.

Furthermore, the action device preferably receives a response data set from a signing device. The action device and the signing device can preferably be included on a common terminal or, more preferably, be separate from one another as independent devices. It is also preferred that the response data set is transmitted to the action device with a signature. The action device is thereby able to read or verify the signature. Subsequently, the action device generates an action data set and transmits the action data set in a direct manner to the auditor device. It is equally preferred that the response data set received by the action device from the signing device does not yet comprise a signature, so that the action device transmits the action data set—after it has been generated on the basis of the response data set—back to the signing device. The signing device would then add a signature to the action data set and send it back to the action device, which would then provide the signed action data set to the auditor device.

In addition, the action device can preferably convert the data object received from the auditor device (or the report generator) into a file format that can be read specifically by the assigned signing device. This advantageously leads to the fact that signing devices can each be configured as different terminal devices with preferably different readable file formats. For example, safety-relevant information, such as a fire that has broken out in the plant for the generation and/or provision of energy, can be transmitted to a signing device that represents, for example, a control center for an emergency call system, with this control center receiving all the information received via a desktop PC. Simultaneously, the proposed system allows another entity, a responsible person/body (for example, the responsible chief engineer), to receive this information, using another terminal, for example, a smartphone.

In another preferred embodiment, the action device is part of a server unit that is spatially separate from the auditor device and the signing device, with the action device being in data communication with the auditor device and the signing device. The advantage of such an arrangement is, among other things, that the system is decentralized, so that in the event of failure of individual components, such as the action device and/or the auditor device, the individual components can be replaced or repaired individually without having to replace the entire system. An action device which is arranged on a decentrally arranged server can advantageously be in data connection with several auditor devices of different systems, so that several systems according to the invention “share” the same action device.

In a further preferred embodiment, the action device generates a requirement data set comprising a signature requirement and at least part of the data object. The requirement data set is preferably—corresponding to the associated signing device—stored in (and transmitted in) a format that is compatible with the associated signing device. The assignment of the signing device to a data object can preferably be based on artificial intelligence algorithms or on an assignment value or assignment information included in the data object—introduced by the auditor device. In this context, the assignment takes place in particular in the auditor device, wherein the action device extracts the assignment value or the assignment information from the first data object and determines an addressing for a signing device and furthermore still creates a request data set. The requirement data set preferably has a signature requirement for at least part of the data object. The signature requirement may preferably be a measure of the relevance of the trigger event and/or the acquired plant-related process variables. The more relevant or critical a piece of information, the greater the signature requirement.

Within the meaning of the invention, a signature is also to be understood as an electronic signature. Electronic signatures are preferably data linked to electronic information that can be used to identify a signer or signature creator and to verify the integrity of the signed electronic information. As a rule, the electronic information is electronic documents. From a technical point of view, the electronic signature thus fulfills the same purpose as a handwritten signature on a paper document.

A digital signature is preferably generated by means of a cryptographic process in which a signer of an electronic document generates a message core from the document using a corresponding algorithm and then encrypts this message core with its secret key to generate a digital signature. The digital signature is then transmitted along with the document. The recipient can also generate a message core from the received document using the same algorithm and decrypt the signature using a key from the signer to obtain the message core from the signature. If the message core from the signature matches the message core generated from the received document, the document has not been altered. Typically, the signer and the recipient must maintain a corresponding key pair, corresponding certificates, and corresponding algorithms in a local infrastructure to be able to generate such digital signatures.

Digital signatures are preferably divided into three categories, namely “simple electronic signature”, “advanced electronic signature” and “qualified electronic signature”. The simple electronic signature preferably has no special requirements. Documents can be signed electronically without identity verification or consent. It is also considered a digital signature without specifying the author or sender. Examples of such a simple signature are as follows: PDF with scanned signature; signature on electronic terminals; email with name. The advanced electronic signature, on the other hand, is already much more secure. It must meet strict identity verification requirements and consequently has a higher probative value than the simple signature. An advanced electronic signature is preferably created using a secret signature key that is uniquely and traceably linked to the signer. The private signature key must be under the “sole control” of the holder. The signature creator is identifiable by attributes that must be verified by a certificate registration authority. The “qualified electronic signature” is preferably an electronic signature that is based on a qualified certificate that is valid at the time it is generated and that was created using a secure and trustworthy signature creation device—for example, a signature card or a combination of Signature Activation Module and HSM.

The action device as well as the signing device preferably have means which can generate and/or read a message or a data set and/or a data object and/or file with a provided signature. This means that corresponding certificates and algorithms, as well as keys, are preferably available in a local infrastructure of the system components (the action device and the signing device). Signatures of all three categories can be used here. Depending on the relevance of the trigger event and/or the acquired process variables, a high or low signature requirement can be assumed. The action device can preferably make the decision of relevance itself by analysis, or this decision is determined by the auditor device, so that this information is transmitted to the action device with the first data set. The relevance is preferably determined via artificial intelligence algorithms.

The action device according to the invention has a plurality of advantages which were not yet known in this way in the prior art, in particular in the context of a plant for the generation and/or provision of energy. On the one hand, the action device advantageously ensures that a “correct” signing device is selected for a specific trigger event and/or process variables. In this way, it is ensured that information is transmitted exclusively to the relevant signing device, bodies and/or persons. As a result, the information received can be processed and signed immediately by the signing device without having to forward the information under certain circumstances because the signing device is not responsible for this information. Furthermore, the action device is preferably able to determine a specific relevance or prioritization for the information value about the trigger event and/or a process variable by generating a specific requirement data set for the information with a specific requirement for a security level and/or security chain.

According to the invention, the action device is preferably adapted to generate an action data set and to make this available to the auditor device. The action data set preferably comprises control and/or regulation commands which can be processed by the auditor device in such a way that it can control and/or regulate plant-related processes. The action data set preferably comprises control or regulation commands that are to be regarded as a reaction to a trigger, occurrence and/or prediction event and reflect an action.

In a preferred embodiment, the signing device is assigned to a body and/or person. For example, the body is a facility selected from the group comprising emergency call control center; hospital; public authority (federal network agency, public order office, public health office, employment office); different departments in a company which preferably operate the plant for the generation and/or provision of energy (e.g. personnel department, management, finance department, responsible technical personnel); supplier company. For example, an individual may work in one area of the aforementioned entities and/or perform activities directly related to the energy generation and/or supply facility, such as a service technician, senior engineer, or piping engineer. For example, in the event of component failures or the need for technician intervention, the possibility of direct legally binding commissioning can be provided using the signature process described.

Preferably, the information about a trigger event and/or process variables reaches one of the above-mentioned bodies and/or persons responsible for this information. The signing device is preferably configured as a terminal device, selected from the group comprising: smartphone, tablet PC, desktop PC, notebook, pager, Internet-capable multimedia device. Preferably, the terminal device is an internet-capable data processing unit, which is configured to directly display the information visually and/or acoustically. As explained at the outset, the signing device or the terminal device can generate an electronic signature for at least part of the requirement data set. For this purpose, the signing device preferably has means which make such a signature possible. Here, certificates, means for encryption may be included in local data on the terminal device. In alternative embodiments, however, it may also be preferred that the signing device accesses an external server, such as a cloud, in order to be able to generate a signature.

In another preferred embodiment, the system is characterized in that the system comprises a report generator,
wherein the report generator comprises and is configured to comprise evaluation applications,
   (i) to analyze the acquired process variables and/or the information value about the trigger event;
   (ii) to identify a pattern, an occurrence event, a prediction event, and/or a course of action;
   (iii) to supplement the first data set with an information value about a pattern, an occurrence event, a prediction event and/or an action option and/or create a second data set with an information value about a pattern, an occurrence event, a prediction event and/or an action option and provide the first and/or second data set to the action device as a data object.

The aforementioned embodiment of the system according to the invention, in particular comprising a report generator, leads to the fact that the acquired plant-related process variables and/or the information value about the trigger event can be subjected to a further detailed analysis, whereby further knowledge valuable for the system is obtained, which enables the best possible automated reaction to a trigger event and/or acquired process variables. In this context, computer-implemented analysis algorithms are preferably executed by the analysis applications included in a report generator. The report generator may thereby (particularly because the evaluation applications preferably comprise artificial intelligence algorithms) advantageously identify a pattern, an occurrence event, a prediction event, and/or a course of action. The report generator can thereby advantageously analyze extremely large amounts of data in a very short time in an automated manner, recognizing patterns and/or features in a data set that cannot be recognized by a human. In particular, this leads to the AI or the evaluation applications and/or the report generator being able to recognize an occurrence event, a prediction event at an early stage (by analyzing the acquired process variables, among other things, also temporally before the actual occurrence of a trigger event) and generate a best possible option for action based on this.

In the event of acute plant malfunctions or predictive maintenance requirements, i.e. if the report generator identifies maintenance activities necessary to avoid imminent failures on the basis of the evaluation of process/operating parameters, it is possible, for example, to propose the replacement of a specific component in conjunction with a time-limited assignment of an access authorization (one-time code) for a defined personnel ID as an action option. Upon confirmation by the required signatures or signing devices, on the one hand, an automated legally compliant commissioning of the technician's assignment, if necessary with ordering of the required spare parts, takes place and, on the other hand, the affected plant part is released via the action device for the time-limited access of the specified technician (on the basis of their personnel ID). All processes in this context are preferably documented and archived with a time stamp.

Modifications of troubleshooting actions proposed on the part of the report generator can also be initiated by the status parameters acting on the evaluation applications. For example, it is conceivable that a proposed execution of predictive maintenance is postponed because the customer supply contract will expire in the foreseeable future or also because the energy supply will be taken over by another energy supplier located in the network.

In a preferred embodiment, the report generator comprises means for generating, processing, storing, transmitting and receiving data. In this respect, the report generator receives at least one of the acquired process variables and/or the information value about the trigger event from the auditor device. Preferably, the report generator and the action device may be comprised on a common terminal device or, more preferably, may be separate from each other as stand-alone devices. It is also preferred that the report generator analyzes the received data from the auditor device and generates a data object based thereon and transmits it to the action device.

Within the meaning of the invention, an action option is preferably to be understood as information which, for example, suggests the type of a reaction or action in response to the trigger event, the occurrence event and/or the prediction event. For example, an action option may include suggesting the deployment of a technician, a valve closure, and/or a deployment of a rescue unit (e.g., fire department). Information about an action option enables the action device or also a signing device or its assigned responsible body and/or person to offer one or more suggestions for further action, in particular a response. The action options are preferably developed in such a way that they can be followed without further considerations or calculations and the signing device and/or the action device preferably generate a command (response data set and/or action data set) which comprises an action selected from these action options. Further, an action option may comprise quantity-related information, preferably comprising information about a number of events and/or costs. Accordingly, quantity-related information about an action option exhibits information about quantity and or numerical characteristics.

Within the meaning of the invention, a prediction event is preferably to be understood as an event which, starting from a point in time, lies in the future (preferably starting from the point in time in which the acquisition device acquires the plant-related process variables). Preferably, this is not necessarily only a specific individual event, but a prediction event can also refer to a future course of events. The evaluation applications can thereby preferably predict a future event or a temporal event course (prediction event) on the basis of an analysis of the acquired plant-related process variables. A prediction event can preferably also predict an event that represents a trigger event and/or an occurrence event.

An occurrence event, on the other hand, is to be understood as an event that has occurred at the time the process variables are acquired. Accordingly, it can be directly related to a trigger event or can also represent a trigger event. Preferably, the occurrence event is more difficult to identify—compared to a trigger event, such that further detailed analyses are necessary for the identification of such an occurrence event.

In a preferred embodiment, the action device receives a data object from the report generator, wherein the data object comprises the first data set with an information value about a pattern, an occurrence event, a prediction event and/or an action option and/or a second data set with one of these information values. Subsequently, the action device preferably assigns this data object to a signing device, wherein the action device incorporates the information values included in the data object for a best possible selection of a signing device. Equally preferably, a requirement data set and/or an action data set is generated by the action device, wherein the information value about a pattern, an occurrence event, a prediction event and/or an action option therefor is taken into account. That is, based on the information values, an optimal requirement data set and/or action data set are generated accordingly. Accordingly, depending on the action option offered, a requirement data set can be generated that has a specific requirement for a signature (signature level, signature chain). In addition, depending on the action option offered, an action data set can be generated that comprises control and regulation commands that implement the proposed action.

In another preferred embodiment, the system is characterized in that the action device is adapted to transmit the response data set to the report generator, which can archive the response data set. It may be further preferred that the requirement data set as well as the action data set may be transmitted to the report generator, which may also store and archive these. As a result of the report generator storing the response data set as well as the request data set and the action data set, the described signature process advantageously enables legally compliant archiving of all transactions. If the report generator is arranged on an external server (and/or at least the storage of the data takes place on an external server, such as a cloud), subsequent access by various—in particular a plurality—of entities is made possible.

In a further preferred embodiment, the system is characterized in that the action device is set up to assign a further signing device to the data object after a defined time interval in the event of a missing response in the form of a response data set. The action device preferably takes over the monitoring of the progress in the signature chain, such that alternative signature options can also be determined in the absence of progress in a defined time interval. In addition, the action device entails the advantage that it is ensured in every case that the relevant information about the trigger event and/or process variables and/or a pattern, an occurrence event, a prediction event and/or an action option reaches a responsible signing device. Even if a signing device does not transmit a response, i.e., a response data set to the action device, a further signing device is preferably assigned to the data object after a predefined time (time interval). Although the further signing device is not the first assignment choice, it may be assigned with respect to a body and/or person having a joint responsibility (accountability) in the context of the trigger event or the process variables or the occurrence event, the prediction event and/or the action.

In a preferred embodiment, the action device assigns a further signing device to the data object if it does not receive a response from the first signing device assigned within a time interval of preferably 1 min to 48 h, more preferably 10 min to 24 h, particularly strongly preferably 15 min to 5 h, in particular 30 min to 2 h, i.e. if the action device does not receive a response data set after the specified time interval. The predefined time interval is preferably to be (re)determined or varied according to the relevance of the trigger event and/or the plant-related process variables and/or patterns, occurrence event, prediction event and/or action option. Artificial intelligence methods can be used to derive time specifications for a release of alternative process steps from the plurality of obtained linked process variables, such as a flow rate of water in a pipe, which then specify the appropriate preferred assigned time intervals for a required feedback of a signing device. In this way, information about the trigger event and/or the plant-related process variables and/or information about a pattern, an occurrence event, a prediction event and/or an option for action is in each case directed to a responsible body and/or person, whereby it can advantageously be ensured that this information has actually been read/processed. It has been shown that the described time intervals determined in this way are particularly well suited for the system according to the invention.

Accordingly, the system according to the invention comprises monitoring of the progress in the signature chain so that, in the absence of progress, alternative signature options can also be executed in a specified time interval.

In another preferred embodiment, the system is characterized in that the signature requirement is dependent on the trigger event, pattern, occurrence event, prediction event, and/or the action option and/or is a requirement with respect to:
a) a signature level comprising a security level and/or;
b) a signature chain that includes a requirement for a signature from at least two signing devices.

By means of the signature requirement, the action device can advantageously already make a corresponding specification with regard to the security level of the requested signature that is at least required from its point of view, which can then be processed automatically without further intervention or further input in this regard by the signing device (or the assigned bodies and/or persons). This can considerably accelerate and simplify the signature process. This is highly advantageous for the user acceptance and enforcement of such a procedure for legally compliant, intelligent control of processes in a plant for the generation and/or provision of energy.

In principle, it may be provided that the signing device can also override the specification of the action device if necessary, i.e. can also generate a response data set with a signature with a lower security level (than the specified minimum security level). Preferably, however, it is provided that the signing device can generate the response data set only if an electronic signature has been generated for at least part of the requirement data set in accordance with the signature specification. Additionally or alternatively, it may be provided that the response data set is only made available to the action device if an electronic signature of the signing device has been generated for at least part of the requirement data set in accordance with the signature specification. This can ensure that it is immediately recognized that the signature process has failed.

In another preferred embodiment, the action device can also be configured as a signature device, so that when a requirement data set is created, it is signed by the action device. The action device selects a preferred security level for its signature. In particular, this need not correspond to the required security level. In further preferred embodiments, the security level of the action-device signature may define the required security level. In particular, this may apply if the action device does not specify anything different with respect to the required security level. Hereby, a particularly fast and smooth processing is possible.

Within the meaning of the invention, the signature level is preferably a security level, whereby the security level preferably defines the type of signature. This is preferably to be divided into the above-mentioned three categories, namely “simple electronic signature”, “advanced electronic signature” and “qualified electronic signature”.

A signature chain is preferably to be understood as a signature sequence in which an electronic document or a data object or a requirement data set is first signed by a first signing device and then passed to a further signing device (or several further signing devices), which also sign the electronic document or the data object or the requirement data set and finally transmit it to the action device as a response data set. In effect, the requirement is for a signature chain, preferably a requirement for multiple signatures by multiple signing devices. It may be preferred that the signing device generates a response data set after each signature and transmits it to the action device, which then forwards this response data set to one or more additional signing devices. The signature chain makes it possible to inform several responsible bodies/persons simultaneously or in quick succession for extremely critical information. In addition, the signature chain can make the response to the critical information more secure because, for example, two or more signatures are required for a system stop (signature of one signing device would not be sufficient).

The signature process can therefore be multi-stage, such that, for example, depending on the severity of the event, the supervisor must also sign in addition to the person responsible. Furthermore, different signature qualities, i.e., different defined security levels of the signatures, can be selected, starting with simple information via a “simple electronic signature” via an “advanced electronic signature” further via a “qualified electronic signature”. In addition, branching in the signature cycle, delegation in the case of absence and also group addressing are possible, where it can be specified that a certain minimum number of persons from a group must sign.

In a further preferred embodiment, the system is characterized in that the response data set comprises a third data set having an information value about an action, on the basis of which the action device generates the action data set, the action data set comprising control and/or regulation commands. Advantageously, this results in the possibility of reacting to (particular) occurrences in the system for generating and/or providing energy, this reaction being initiated from a location which is remote from the system. The design of the system makes it possible in particular to react very quickly. Furthermore, such a system offers advantages in terms of efficiency and cost-effectiveness, because instructions and/or maintenance from a remote location can, for example, eliminate the need for travel by persons. Furthermore, several instructions can be provided simultaneously to the auditor device.

This can result in direct feedback effects on the IoT system via the action device, e.g. a system stop can be initiated in the event of safety-relevant incidents. The presence of an action device can further lead to increased safety of the system. The information with feedback effects on the system for the generation and/or provision of energy is preferably provided by the action data set or third data set under strict conditions. In this context, the action device may be particularly well secured and resistant to manipulation as a single system component.

Preferably, the third data set comprises data in the context of the control and/or regulation of the plant for the generation and/or provision of energy, for example of the valves comprised in a plant. The auditor device is thereby configured to implement and execute the control and/or regulation commands comprised in the third data set.

In a further preferred embodiment, the system is characterized in that the report generator and/or the action device are arranged on a server. As already described, there are advantages associated with having the action device and/or the report generator on a server. For example, multiple systems may share a report generator and/or action device. The report generator and/or the action device can be maintained and adjusted remotely. Furthermore, such an arrangement of the report generator and/or the action device on a server results in the fact that the report generator and/or the action device need not be included in the system for generating and/or providing energy itself, so that this in turn does not take up any space in the system.

In a further preferred embodiment, the system is characterized in that the transmission of the requirement data set, the response data set, the action data set, the data object is performed as a data transmission process via IP-based communication, wherein at least one data transmission process is cryptographically secured by a security module.

IP-based communication is preferably carried out via Internet protocols, i.e. network communication protocols. The transmission of data via network communication protocols advantageously enables a transmission of large amounts of data, such that under certain circumstances even the live transmission of video and detailed photo sequences are made possible. Furthermore, such a transmission enables remote control of components such as camera and/or microphone. The protocols are selected from the group comprising https, http POST, SIP, SFTP, FTP, SMTP.

In a preferred embodiment, the “http POST” protocol is used as the transmission protocol. In this context, the first data set and/or the second data set and/or the third data set and/or the requirement data set and/or the response data set and/or the action data set are transmitted as a so-called payload using “http POST”. The advantage of “http POST” is that the entities are not burdened with having to maintain a connection for an extended period of time. Furthermore, “http POST” can be implemented in the system according to the invention in a simple way without great requirements and is in particular extremely user-friendly.

In a further preferred embodiment, the “SFTP” protocol is used as the transmission protocol. A significant advantage of “SFTP” is that communication is encrypted. This means that attackers cannot easily view the data traffic. The encryption is not provided by “SFTP” itself, but by the underlying communication channel, which is why various methods can be used. In addition to copying files in both directions—from a client to a server and vice versa—directories can also be read out and listed via “SFTP”, and files on the server can be deleted by the client.

In a further preferred embodiment, an SFTP server is preferably interposed between the individual system components, i.e. the auditor device, the action device and/or the report generator, when transferring data using an “SFTP” protocol. In this preferred variant, SFTP files are exchanged between a first system component and the SFTP server, with the SFTP server then converting these files and making them available to the second system component via an “http POST” protocol.

In addition, the preferred use of a security module that cryptographically secures all data transmission processes makes the proposed system particularly secure against data manipulation, data theft and/or data loss. Preferably, the security module is designed as an HSM. It is preferred in the sense of the invention that the HSM is a hardware-based cryptographic module that preferably has FIPS 140-2 certification. By providing for the auditor device, report generator, action device and/or signing device operating with FIPS certification, in particular a technical problem is solved by technical means, namely the provision of particularly secure data transmission within the system. The HSM may be formed by or comprise a single chip module, an autonomous multichip module or an embedded multichip module.

Preferably, the HSM is adapted to store data in a particularly secure manner. In particular, an HSM is capable of generating, storing, using, and/or maintaining critical security parameters, such as passwords, confidential data, or keys for encrypting data. For example, the keys may be symmetric or asymmetric. Advantageously, HSMs may be used as cryptographic coprocessors. In preferred embodiments, an HSM may include battery-powered circuitry and/or voltage monitoring. In particular, this allows for the integration or provision of a real-time clock for proper timekeeping and time stamping, which can ensure, for example, that expired keys can no longer be used. In addition, an HSM may include redundant memory that can be used, for example, to simultaneously use multiple technologies to generate additional data security. In particular, the HSM can be used to implement a public key infrastructure at the highest level, as is known to persons skilled in the art.

The fact that the system components are preferably equipped with a security module means that all data transmission processes can be cryptographically secured. Particularly advantageously, this makes the system resistant to manipulation and unauthorized reading of the data.

It is within the meaning of the invention that an HSM comprises a chain of certificates that are preferably loaded onto the device before the HSM is put into operation. The HSM is further adapted to generate its own private and public device keys. Preferably, the private key does not leave the HSM at any time, while the public key can be delivered externally, for example to a decentralized server for signing there. In return, the HSM can receive a personalized, signed device certificate that allows the HSM to significantly increase security in an Internet of Things (IOT) system. The HSM can then be recognized and authenticated by the decentralized server as a “real” security device, which is made possible in particular by assigning a unique identifier. In this way, authenticated TLS connections can be established in a particularly uncomplicated manner (Transport Layer Security).

The plant according to the invention is preferably linked via a gateway by means of a token or an ID (based on a private key infrastructure PKI of a Data Management Center DMC) by an operator to an auditor device, which delivers process data to an expert system consisting of a report generator and various associated evaluation applications, which automatically proposes troubleshooting actions that enable documented feedback effects on the plant by the action device after prior release by the coupled legally compliant digital signature procedure (signing devices).

In another preferred embodiment, the system is characterized in that the first and/or second and/or third data set comprises data selected from the group comprising location data, personal data, time-related data, audio data, image data, analysis data, process data, usage data, text data and/or video data,
wherein the information value about the trigger event in the first data set comprises quality-related and/or quantity-related information about the trigger event.

The listed data may include wide-ranging information about the plant for generating and/or providing energy so that further information, such as a trigger event, a pattern, an occurrence event, a prediction event, and/or a course of action, can be derived therefrom. In addition to identifying a trigger event, the data are also suitable as such for monitoring processes.

Quality-related information about a trigger event preferably includes information about the nature, severity, scope, and/or relevance of an event that has occurred.

Quantity-related information, on the other hand, preferably comprises information about a number of events and/or costs. Accordingly, quantity-related information about a trigger event has information about quantity-related and or number-related characteristics.

In a further preferred embodiment, the system is characterized in that the auditor device is adapted to initiate control and/or regulation of a sensor system and/or actuator system with reference to the action data set, the sensor system and actuator system being selected from the group comprising: electricity, water and energy meters, temperature and pressure transducers, valve, pump, electrical switchgear, access control.

It is understood that actuator technology is a subfield of drive system technology that deals with an actuator as a technical element. The term actuator technology generally covers the generation of a movement or a deformation and is therefore relevant for various technical disciplines, for example in control engineering, automation technology or mechatronics. Actuators preferably convert signals (e.g. commands emanating from the auditor device) into mechanical motion or other physical variables (e.g. pressure or temperature) and thus actively intervene in a process.

In a further preferred embodiment, the system is characterized in that plant-related process variables are selected from the group comprising electricity, water or heat consumption, access monitoring, operating parameters such as plant lubrication, wear, temperature, contamination.

In a further preferred embodiment, the system is characterized in that the analysis of the acquired process variables and/or the identification of the trigger event and/or the pattern and/or the occurrence event and/or the prediction event and/or the action option is performed via artificial intelligence algorithms. The use of artificial intelligence (AI for short) to analyze data entails significant advantages over analysis by conventional (computer-implemented) methods and/or also over manual analysis by a human observer. Thus, an AI can advantageously analyze extremely large amounts of data in a very short time in an automated manner. Furthermore, AI algorithms can recognize patterns and/or features in a data set that are not recognized by a human or conventional algorithms. In particular, this means that the AI can recognize trigger events occurring at an early stage (well before the actual occurrence of the trigger event).

In a further preferred embodiment, the artificial intelligence algorithms preferably comprise machine learning algorithms. It is understood that machine learning algorithms are a subfield of artificial intelligence. Machine learning uses mathematical and statistical models to “learn” from data sets. In general, machine learning algorithms have the advantage that information that is too complex for a human observer can be automatically extracted from a large data set. There are a variety of machine learning algorithms that can be broadly categorized into three different learning methods: supervised learning, unsupervised learning, and reinforcement learning.

In accordance with the invention, supervised learning methods are particularly preferred for analyzing the acquired plant-related process variables. In the supervised learning method, a so-called training process is first carried out. Here, training data is provided in the form of input data together with the corresponding target data. The purpose of training in machine learning methods is generally to adjust parameters of a function so that the function is subsequently able to determine the target value with a high degree of accuracy from the corresponding input value. The adjusted function is then used after the training process to predict target data for previously unseen input data. The function is described by a mathematical and/or statistical model.

In a preferred embodiment, the function is configured using support vector machines, Bayesian networks and/or decision trees. Particularly preferably, the function is described by an artificial neural network. In accordance with the invention, the artificial neural networks can have different architectures and be configured, for example, as Deep Feed Forward (DFF) Network, Recurrent Neural Network (RNN), Deep Convolutional Network (DCN), Deconvolutional Network (DN), Convolutional Neural Network (CNN), Deep Residual Network (DRN), Boltzmann Machine, Time Delay Neural Networks (TDNNs).

In the sense of the invention, the input data are preferably defined by the plant-related process variables, namely preferably power, water or heat consumption, access monitoring, operating parameters such as plant lubrication, wear, temperature, contamination (without being limited to these).

According to the invention, target data are preferably defined by the classification of the input data into a specific class and/or the occurrence of specific target data (events) is determined on the basis of the input data. Likewise, probabilities for membership in a specific class can also be output as target data or probabilities for an occurrence of specific target data (events). Preferably, the classes are divided into specific trigger events. For example: “failure of a refrigeration unit”; “fire of the plant”; “overload of the generator”; “no storage capacity”; “unauthorized persons have gained access to the warehouse”. Accordingly, as a so-called classification algorithm, the AI can output whether a particular trigger event, prediction event, or occurrence event is occurring based on the mapping of the input data onto corresponding target data.

Equally preferably, a machine learning algorithm may use as input (input data) the trigger event, prediction event, or occurrence event determined in a previous step. Accordingly, the machine learning algorithm may determine as output (target data) a signing device responsible for the trigger event, or it may provide a course of action.

In another preferred embodiment, the unsupervised learning method is used to analyze or process the plant-related process variables. In unsupervised learning, the algorithm attempts to identify patterns in the input data that deviate from a structureless background noise. The function in the training process is guided only by the similarities in the input data and adjusts its parameters accordingly, such that no output data is used for the training process.

In a preferred embodiment, the unsupervised learning method is used to perform segmentation or clustering of the input data or, preferably, compression of the input data. The person skilled in the art is familiar with the terms clustering, segmentation and compression in connection with machine learning methods.

In a preferred embodiment, the unsupervised learning algorithm preferably comprises Principal Component Analysis (PCA) and/or the K-Means algorithm and/or at least one neural network.

The proposed system further preferably features artificial intelligence algorithms with Unsupervised Learning methods. In this context, a data set of acquired plant-related process variables can be pre-processed via unsupervised learning methods, for example by grouping (clustering) relevant data in order to subsequently obtain a classification algorithm for determining a trigger event and/or a signing device based on this “filtered” data.

As already described, in both methods mentioned above, so-called training processes are carried out in a first step to determine optimal parameters of an above-mentioned machine learning function. Based on the adapted function, various statements are made after the training for previously unknown input data.

In another preferred embodiment, the reinforcement learning method is used for the analysis or processing of the acquired process variables. In the reinforcement learning method, on the other hand, the training process takes place continuously even after the parameters of a function have been adjusted. Via “trial and error”, effects of different statements are observed and evaluated using the adapted function for previously unknown input data. In response to these statements, the algorithm receives feedback, represented abstractly in the form of a reward or punishment. Whereupon the algorithm further optimizes the function based on its parameters. Accordingly, the algorithm continuously adapts or modifies the function of the machine learning process.

In a preferred embodiment, the reinforcement learning method comprises the Q-learning method and/or aforementioned neural networks and/or further neural networks as well as further algorithms known to the person skilled in the art.

In a further preferred embodiment, the invention relates to a method for legally compliant, intelligent control of processes in a plant for the generation and/or provision of energy comprising the following steps:
a. automated acquisition of plant-related process variables by an acquisition device;
b. identification of a trigger event and generation of a first data set by an auditor device, the first data set comprising at least one of the acquired process variables and/or an information value about the trigger event and being transmitted as a data object to the action device;
c. determining a first and/or second signing device responsible for the data object;
d. transmission of a first and/or second requirement data set to the first and/or second signing device associated with the data object by the action device, wherein the first and/or second requirement data set comprises a signature requirement and at least part of the data object;
e. generation of a first and/or second response data set by the first and/or second signing device, the first and/or second response data set comprising an electronic signature for at least part of the first and/or second requirement data set;
f. transmission of the first and/or second response data set to the action device and/or to a further signing device;
g. transmission of an action data set to the auditor device by the action device, wherein the action data set comprises control and/or regulation commands.

The combination of the present process steps leads to a surprising synergistic effect, which results in the advantageous features and the associated overall success of the invention, whereby the individual features interact with each other. An important advantage of the method according to the invention is the necessity of extremely few process steps and system components, while nevertheless generating an extremely secure infrastructure for legally compliant, intelligent control of processes in a plant for the generation and/or provision of energy.

A person skilled in the art recognizes that the advantages, technical effects and preferred embodiments discussed in the context of the system according to the invention apply analogously to the method according to the invention for the legally compliant, intelligent control of processes in a plant for the generation and/or provision of energy, which makes use of the system according to the invention.

Likewise, all advantages, technical effects and preferred embodiments described in the context of the method are transferable to the system.

In a further preferred embodiment, the method is characterized in that the following steps are interposed between method steps b and c:
b1. transmission of the first data set to a report generator;
b2. identification of a pattern, an occurrence event, a prediction event, and/or a course of action based on an analysis of the acquired process variables and/or the information value about the trigger event;
b3. supplementing the first data set and/or creating a second data set with an information value about the pattern, occurrence event, prediction event, and/or action option.
b4. transmission of the first and/or second data set as a data object to the action device.

In a further preferred embodiment, the method is characterized in that the one further signing device generates a further response data set with a further electronic signature and transmits it to the action device. This advantageously enables the application of a signature chain, which ensures increased security to a signature, because in certain cases a process in the plant for the generation and/or provision of energy, for example, can only be continued or aborted if several signing devices have received and signed the information about a triggering event.

In a further preferred embodiment, the method is characterized in that the auditor device initiates control and/or regulation of a sensor system and/or actuator system with reference to the action data set.

In a further preferred embodiment, the method is characterized in that the action device assigns a further signing device to the data object if the response data set is not transmitted after a specified time interval. This advantageously ensures that the information about a trigger event, prediction event, occurrence event, action option and/or the process variables as such reach a signing device, although a first responsible signing device may be impeded (e.g. by power failure).

In a further preferred embodiment, the method is characterized in that the analysis of the acquired process variables and/or the determination of the trigger event and/or the pattern and/or the occurrence event and/or the prediction event and/or the option for action is carried out via artificial intelligence algorithms. The use of artificial intelligence in the method according to the invention leads to an optimization of processes and an elimination of repetitive tasks, so that efficiency can be increased through more targeted and thus more sustainable use of resources, time savings and minimization of waste.

### FIGURES

In the following, the invention will be explained in more detail with reference to figures, without being limited to them.

### Short Description of the Images

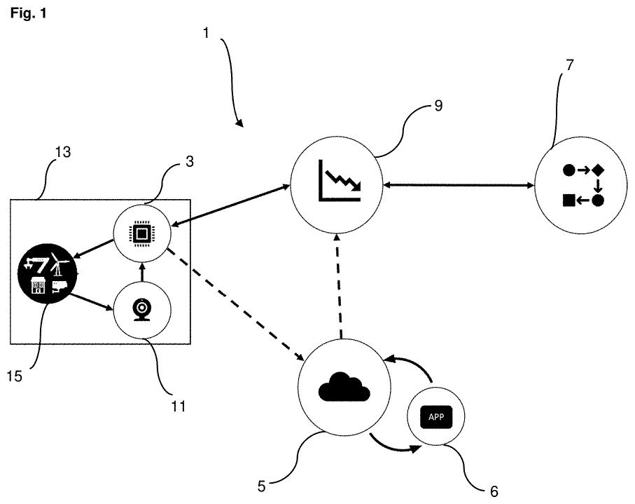

FIG. 1 Schematic representation of a preferred arrangement of the system according to the invention

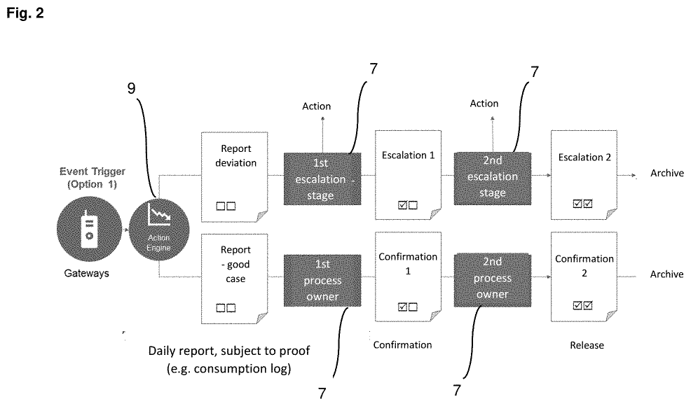

FIG. 2 Schematic diagram of a preferred embodiment of the method according to the invention

### DETAILED DESCRIPTION OF THE IMAGES

FIG. 1 illustrates a preferred arrangement of system components for a system 1 for legally compliant, intelligent control of processes in a plant 13 for generating and/or supplying energy. The system 1 preferably comprises an acquisition device 11, an auditor device 3, an action device 9, a signing device 7 and optionally a report generator 5. The signing device 7 is preferably assigned to plant-related processes 15 and is adapted to automatically acquire plant-related process variables. These are preferably transmitted to the auditor device 3, which analyzes the acquired process variables and identifies a trigger event. Furthermore, the auditor device 3 is able to generate a first data set which comprises at least one of the acquired process variables and/or an information value about the trigger event.

The data set can then preferably be transmitted as a data object to the action device 9. The action device 9 is preferably adapted to determine a signing device 7 responsible for the data object. Here, the action device 9 preferably has a database with the addressing information of all signing devices 7. After an assignment, a requirement data set is preferably created by the action device 9, which has a request via a signature level and a signature chain. This requirement data set is preferably transmitted to the responsible signing device 7. The signing device 7 preferably generates a response data set, which comprises an electronic signature for at least part of the requirement data set. Furthermore, the response data set may be transmitted to the action device 9 and/or to another signing device 7. Finally, an action data set may be generated by the action device 9 and provided to the auditor device 3.

The auditor device 3 is also adapted to provide the first data set to the report generator 5. Provided that the report generator 5 receives the first data set, it preferably analyzes the acquired process variables and/or the information value about the trigger event. In the course of this, the report generator 5 has evaluation applications 6. The evaluation applications 6 are preferably to be understood as computer-implemented algorithms, preferably based on artificial intelligence. Thus, a pattern, an occurrence event, a prediction event and/or a course of action can preferably be recognized by the evaluation applications 6 and/or the report generator 5. In this case, the first data set is either supplemented with an information value about a pattern, an occurrence event, a prediction event and/or an action option, or a second data set is created comprising an aforementioned information value. Subsequently, the first and/or second data set is delivered to the action device 9 as a data object.

Under the influence of the pattern, occurrence event, prediction event and/or action option identified by the report generator 5, the action device 9 can preferably determine a relevant signing device 7 and/or automatically generate a corresponding action data set. The action data set thereby preferably comprises control and/or regulation commands and is preferably transmitted to the auditor device 3.

The auditor device 3 is further adapted to initiate control and/or regulation of a sensor system and/or actuator system in the plant 13 for generating and/or providing energy with reference to the action data set, so that plant-related processes are controlled and/or regulated in response to the trigger event.

FIG. 2 shows a preferred embodiment of the method according to the invention in a schematic sequence representation. Preferably, the action device 9 receives—as already explained in FIG. 1 —information about a trigger event on the basis of a data object from an auditor device 3 (not shown in FIG. 2) and/or an information value about a pattern, an occurrence event, a prediction event and/or an action option from the report generator 5 (not shown in FIG. 2). The action device 9 then preferably determines a responsible signing device 7 (here: 1st process owner or 1st escalation level) and assigns the data object to it. Furthermore, the action device 9 creates a requirement data set with a requirement for a signature level and signature chain and transmits this requirement data set to the signing device 7 assigned to the data object. In the present case, the signature chain, requires the signature of two signing devices 7. The signing device 7 preferably creates a response data set after receiving the requirement data set, the response data set comprising an electronic signature for at least part of the requirement data set. Finally, the signing device 7 transmits the response data set to a further signing device 7 (here: 2nd process owner or 2nd escalation level). The further signing device 7 also creates a response data set with an electronic signature for at least part of the request data set.

### REFERENCE LIST

1 System
3 Auditor device
5 Report generator
6 Evaluation applications
7 Signing device
9 Action device
11 Acquisition device
13 Plant for the generation and/or supply of energy
15 Plant-related processes

1. A system (1) for the legally compliant, intelligent control of processes in a plant (13) for the generation and/or provision of energy, the system (1) comprising at least an acquisition device (11), an auditor device (3), an action device (9) and a signing device (7),
characterized in that
a) the acquisition device (11) is adapted to automatically acquire plant-related process variables;
b) the auditor device (3) is adapted to
(i) analyze the acquired process variables and identify a trigger event;
(ii) generate a first data set, the first data set comprising at least one of the acquired process variables and/or an information value about the trigger event;
(iii) transmit the first data set as a data object to the action device (9);
c) the action device (9) is adapted to
(i) determine a signing device (7) responsible for the data object;
(ii) transmit a requirement data set to the signing device (7) assigned to the data object, the requirement data set comprising a signature requirement and at least part of the data object;
(iii) generate an action data set and provide it to the auditor device (3) and;
d) the signing device (7) is adapted to
(i) generate a response data set comprising an electronic signature for at least part of the requirement data set;
(ii) transmit the response data set to the action device (9) and/or to a further signing device (7).

2. The system (1) according to claim 1
characterized in that
the system (1) comprises a report generator (5),
wherein the report generator (5) comprises evaluation applications (6) and is adapted to
(i) analyze the acquired process variables and/or the information value about the trigger event;
(ii) identify a pattern, an occurrence event, a prediction event, and/or a course of action;
(iii) supplement the first data set with an information value about a pattern, an occurrence event, a prediction event and/or an action option and/or create a second data set with an information value about a pattern, an occurrence event, a prediction event and/or an action option and provide the first and/or second data set to the action device (9) as a data object.

3. The system (1) according to claim 2
characterized in that
the action device (9) is adapted to
transmit the response data set to the report generator (5), which can archive the response data set.

4. The system (1) according to claim 1
characterized in that
the action device (9) is adapted to
assign a further signing device (7) to the data object after a defined time interval in the event of a missing response by a response data set.

5. The system (1) according to claim 1
characterized in that
the signature requirement is dependent on the trigger event, pattern, occurrence event, prediction event and/or the action option and/or is a requirement with respect to:
a) a signature level comprising a security level and/or;
b) a signature chain comprising a requirement for a signature of at least two signing devices (7).

6. The system (1) according to claim 1
characterized in that
the response data set comprises a third data set having an information value about an action, on the basis of which the action device (9) generates the action data set, wherein the action data set comprises control and/or regulation commands.

7. The system (1) according to claim 2
characterized in that
the report generator (5) and/or the action device (9) are arranged on a server.

8. The system (1) according to claim 1
characterized in that
the transmission of the requirement data set, the response data set, the action data set, the data object takes place as a data transmission process via IP-based communication, wherein at least one data transmission process is cryptographically secured by a security module.

9. The system (1) according to claim 1
characterized in that
the first and/or second and/or third data set comprises data selected from the group comprising location data, personal data, time-related data, audio data, image data, analysis data, process data, usage data, text data and/or video data,
wherein the information value about the trigger event in the first data set comprises quality-related and/or quantity-related information about the trigger event.

10. The system (1) according to claim 1 characterized in that
the auditor device (3) is adapted to initiate control and/or regulation of a sensor system and/or actuator system with reference to the action data set, the sensor system and actuator system being selected from the group comprising: electricity, water and energy meters, temperature and pressure transmitters, valve, pump, electrical switchgear, access control.

11. The system (1) according to claim 1
characterized in that
plant-related process variables are selected from the group comprising electricity, water or heat consumption, access monitoring, operating parameters such as plant lubrication, wear, temperature, contamination.

12. The system (1) according to claim 1
characterized in that
the analysis of the acquired process variables and/or the identification of the trigger event and/or the pattern and/or the occurrence event and/or the prediction event and/or the action option is carried out via artificial intelligence algorithms.

13. A method for legally compliant, intelligent control of processes in a plant (13) for the generation and/or provision of energy comprising the following steps:
a) automated acquired of plant-related process variables by an acquisition device (11);
b) identification of a trigger event and generation of a first data set by an auditor device (3), the first data set comprising at least one of the acquired process variables and/or an information value about the trigger event and being transmitted as a data object to an action device (9);
c) determination of a first and/or second signing device (7) responsible for the data object;
d) transmission of a first and/or second requirement data set to the first and/or second signing device (7) associated with the data object by the action device (9), wherein the first and/or second requirement data set comprises a signature requirement and at least part of the data object;
e) generation of a first and/or second response data set by the first and/or second signing device (7), the first and/or second response data set comprising an electronic signature for at least part of the first and/or second requirement data set;
f) transmission of the first and/or second response data set to the action device (9) and/or to a further signing device (7);
g) transmission of an action data set to the auditor device (3) by the action device (9), the action data set comprising control and/or regulation commands.

14. The method according to claim 13
characterized in that
the following steps are interposed between process steps b and c:
b1) transmission of the first data set to a report generator (5);
b2) recognition of a pattern, an occurrence event, a prediction event and/or a
predictive event, and/or a course of action based on an analysis of the acquired process variables and/or the information value about the trigger event;
b3) supplementation of the first data set and/or creation of a second data set with an information value about the pattern, occurrence event, prediction event, and/or action option.
b4) transmission of the first and/or second data set as a data object to the action device (9).

15. The method according to claim 13
characterized in that
the one further signing device (7) generates a further response data set with a further electronic signature and transmits it to the action device (9).

16. The method according to claim 13
characterized in that
the auditor device (3) initiates a control and/or regulation of a sensor system and/or actuator system with reference to the action data set.

17. The method according to claim 13
characterized in that
the action device (9) assigns a further signing device (7) to the data object if the response data set is not transmitted after a specified time interval.

18. The method according to claim 13
characterized in that
the analysis of the acquired process variables and/or the determination of the trigger event and/or the pattern and/or the occurrence event and/or the prediction event and/or the action option is performed via artificial intelligence algorithms.
